(19) United States
(12) Patent Application Publication
(10) Pub. No.: US 2009/0293566 A1
(43) Pub. Date: Dec. 3, 2009

(54) Key Locking Device for Immobilizer Systems

(75) Inventor: Jin Sang CHUNG, Suwon-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/336,431

(22) Filed: Dec. 16, 2008

(30) Foreign Application Priority Data
May 27, 2008 (KR) 10-2008-0049319

(51) Int. Cl. E05B 11/06

(52) U.S. Cl. 70/390

(57) ABSTRACT

A key locking device for an immobilizer system may include a rotor casing having an inner space therein, a rotor rotatably coupled to the rotor casing in the inner space thereof and having a first key hole formed in a front end of the rotor, a locking member selectively coupling the rotor, the rotor casing, and the vehicle key according to rotation of the vehicle key, and/or the vehicle key to be inserted into the rotor through the first key hole and having a locking notch, so that when the vehicle key is inserted into the rotor through the first key hole and rotated along the rotor casing, the vehicle key activates the locking member to lock the vehicle key to the rotor through the locking notch of the vehicle key such that the vehicle key is prevented from being released from the rotor.

### CROSS-REFERENCE TO RELATED APPLICATION

The present application claims priority to Korean Patent Application Number 10-2008-0049319 filed May 27, 2008, the entire contents of which application is incorporated herein for all purposes by this reference.

### BACKGROUND OF THE INVENTION

1. Field of the Invention

The present invention relates to a key locking device for immobilizer systems which prevents a vehicle key used in an immobilizer system from being released after the key is inserted into the key locking device and is rotated, the immobilizer system identifying a user by checking an identification code of the key with preset information.

2. Description of Related Art

Generally, in conventional key locking devices for vehicle doors and the ignition, a user is determined as authorized or not for access thereto according to the vehicle key's unique shape, for example, uniqueness of the lines. That is, only when the lines of the vehicle key correspond to a tumbler of a rotor the key can be used to operate the vehicle.

A conventional key locking device of a starting system for a vehicle will be described with reference to FIG. 1. In the starting system, if it is determined that a key is not an authorized key, a steering unit 30 is locked by a steering locking unit 54 and a start locking unit 52 prevents the vehicle from starting using the incorrect key. The steering locking unit 54 and the start locking unit 52 are integrated with each other and use a mechanical method to prevent the vehicle from starting. However, in such a case as the above where the steering locking unit 54 and the start locking unit 52 are integrated with each other, the inter-changeability of components deteriorates because out of necessity the design varies depending on the kind of vehicle. In addition, the degree of freedom in an installation position of a key hole of a starting apparatus 10 is restricted. Furthermore, because of the installation of the starting locking unit 52, the size of the starting apparatus 10 is increased so that it may injure a driver when the vehicle is involved in a collision.

A representative example of conventional door locking structures using keys was proposed in Korean Patent Laid-open Publication No. 2006-005801. In this door locking structure, a rotor has several tumblers corresponding to the shape of the private key, and only when a key shape corresponds to the tumblers can the key be rotated. However, this door locking structure is very complex, and because the key can be easily copied a security problem may occur.

Recently, with regard to user recognition for vehicles, immobilizer systems were introduced. A representative example of the immobilizer systems was proposed in Korean Patent Laid-open Publication No. 2007-0004161. In the immobilizer system, unique identification data is preset in a key of a vehicle. When one desires to open a door of the vehicle or start the vehicle, the identification data of the key is checked with information preset in the vehicle through radio communication. Only when the identification data of the key corresponds to the preset information is the opening of the door or the starting of the vehicle allowed.

In the case of a vehicle having an immobilizer system, a steering locking unit is not legally required so that key locking devices having complex structures are no longer required. If an immobilizer system and a conventional key locking device are used together, their functions overlap and the production cost is increased. Therefore, it is sufficient if the immobilizer system conducts only a user recognition function and the key locking device prevents a key from being undesirably released from a key hole after the key is inserted into the key hole and is rotated in one direction.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a key locking device for immobilizer systems which has a simple structure such that it only functions to prevent a vehicle key from being undesirably released after the key has been rotated from the initial position thereof, thus reducing the production cost, and increasing the degrees of freedom available for the design.

In an aspect of the present invention, a key locking device for an immobilizer system which prevents a vehicle key from being released after the vehicle key is rotated from an initial position thereof, the immobilizer system identifying a user by checking an identification code of the vehicle key with stored information, may include a rotor casing having a cylindrical inner space therein, with a retraction recess formed in an inner surface of the rotor casing, a rotor rotatably coupled to the rotor casing in the inner space thereof and having a first key hole formed in a front end of the rotor and a guide groove formed in the rotor at a position adjacent to the retraction recess of the rotor casing, a disk slidably installed in the rotor through the guide groove, the disk being elastically biased outwards, with a second key hole formed in the disk so that the vehicle key passes through the second key hole, and a locking protrusion provided on an upper end of the disk, the locking protrusion selectively movable into the retraction recess of the rotor casing through the guide groove of the rotor according to rotation of the vehicle key, and/or the vehicle key to be inserted into the rotor through the first key hole, with a locking notch formed in the vehicle key, so that when the vehicle key is inserted into the rotor, the vehicle key passes through the second key hole of the disk and moves the disk in a direction in which the locking protrusion of the disk is released from the retraction recess, and when the vehicle key is rotated along with the disk and the rotor from a position at which the vehicle key is inserted into the rotor, the disk is engaged with the locking notch of the vehicle key such that the vehicle key is prevented from being released from the rotor.

The disk may be supported in the rotor by a spring so as to be movable along the guide groove formed in the rotor.

A contact protrusion may be provided in a lower end of the second key hole so that when the vehicle key is inserted into the second key hole, the contact protrusion is pushed by a lower edge of the vehicle key and thus the disk is moved in the direction in which the locking protrusion of the disk is released from the retraction recess.

In another aspect of the present invention, a key locking device for an immobilizer system which prevents a vehicle key from being released after the vehicle key is rotated from an initial position thereof, the immobilizer system identifying a user by checking an identification code of the vehicle key with stored information, may include a rotor casing having a cylindrical inner space therein, with a flange provided on an inner surface of the rotor casing, the flange extending a predetermined length along a rotation trajectory of the vehicle key, a rotor rotatably coupled to the rotor casing in the inner space thereof, with a first key hole formed in a front end of the rotor, and a flange insert slot formed at a predetermined position in the rotor so that the flange of the rotor casing is slidably inserted into the flange insert slot, and/or the vehicle key to be inserted into the rotor through the first key hole, with a locking notch formed in the vehicle key, so that when the vehicle key is rotated from a position at which the vehicle key is inserted into the rotor, the vehicle key rotates with the rotor and the flange of the rotor casing is inserted into and locked to the locking notch, thus preventing the vehicle key from being released from the rotor.

The flange may be provided in the rotor casing such that when the vehicle key is inserted into the rotor, the flange is disposed on a side of the vehicle key.

In further another aspect of the present invention, a key locking device for an immobilizer system which prevents a vehicle key from being released after the vehicle key is rotated from an initial position thereof, the immobilizer system identifying a user by checking an identification code of the vehicle key with stored information, may include a rotor casing having an inner space therein, a rotor rotatably coupled to the rotor casing in the inner space thereof and having a first key hole formed in a front end of the rotor, a locking member selectively coupling the rotor, the rotor casing, and the vehicle key according to rotation of the vehicle key, and/or the vehicle key to be inserted into the rotor through the first key hole and having a locking notch, so that when the vehicle key is inserted into the rotor through the first key hole and rotated along the rotor casing, the vehicle key activates the locking member to lock the vehicle key to the rotor through the locking notch of the vehicle key such that the vehicle key is prevented from being released from the rotor.

The rotor casing may include a retraction recess formed in an inner surface thereof, the rotor may include a guide groove formed in a co-axial direction with the retraction recess of the rotor casing, and the locking member may include a disk slidably installed in the guide groove of the rotor and elastically biased outwards, the disk having a second key hole so that when the vehicle key passes through the first and second key holes, the vehicle key moves the disk in a direction in which the disk is released from the retraction recess, and then when the vehicle key is rotated along with the disk, the disk is inserted into the locking notch of the vehicle key such that the vehicle key is prevented from being released from the rotor.

The locking notch of the vehicle key may include an upper locking notch and a lower locking notch, and when the vehicle key passes through the first and second key holes the disk is engaged with the lower locking notch of the vehicle key.

When the vehicle key is rotated along with the disk, the disk may be released from the lower locking notch and inserted into the upper locking notch of the vehicle key such that the vehicle key is prevented from being released from the rotor.

The upper locking notch and the lower locking notch may be disposed symmetrically with respect to a longitudinal axis of the vehicle key.

The disk may be supported in the rotor by an elastic member so as to be movable along the guide groove formed in the rotor.

The elastic member may be a spring.

A locking protrusion may be provided on an upper end of the disk, the locking protrusion selectively moving into the retraction recess of the rotor casing by rotation of the vehicle key.

A contact protrusion may be provided in a lower end of the second key hole so that when the vehicle key is inserted into the second key hole, the contact protrusion is pushed downwards by a lower edge of the vehicle key and the disk is thus moved in the direction in which the locking protrusion of the disk is released from the retraction recess.

The contact protrusion may be a triangular shape.

The rotor casing may include a flange integrally provided on an inner surface thereof the flange extending in a predetermined length along a rotation trajectory of the vehicle key, and the rotor may include a flange insert slot along a rotation direction of the flange so that the flange of the rotor casing is inserted into the flange insert slot, and when the vehicle key is rotated from a position at which the vehicle key is inserted into the rotor, the vehicle key rotates with the rotor and the flange of the rotor casing is inserted into and locked to the locking notch, thus preventing the vehicle key from being released from the rotor.

The flange may be provided in the rotor casing such that when the vehicle key is inserted into the rotor, the flange is disposed on one side of the vehicle key.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view showing a key locking device according to a conventional technique.

FIG. 2 is a front view showing an exemplary key according to the present invention.

FIG. 3 is a perspective view of an exemplary rotor casing of a key locking device for immobilizer systems according to the present invention.

FIG. 4 is a sectional view of the key locking device of FIG. 3.

FIG. 5 is a perspective view of a disk of the key locking device of FIG. 3.

FIG. 6 is a perspective view of an exemplary rotor of a key locking device for immobilizer systems according to the present invention.

FIG. 7 is a perspective view of a rotor casing of the key locking device of FIG. 6.

FIG. 8 is a sectional view of the key locking device of FIG. 6.

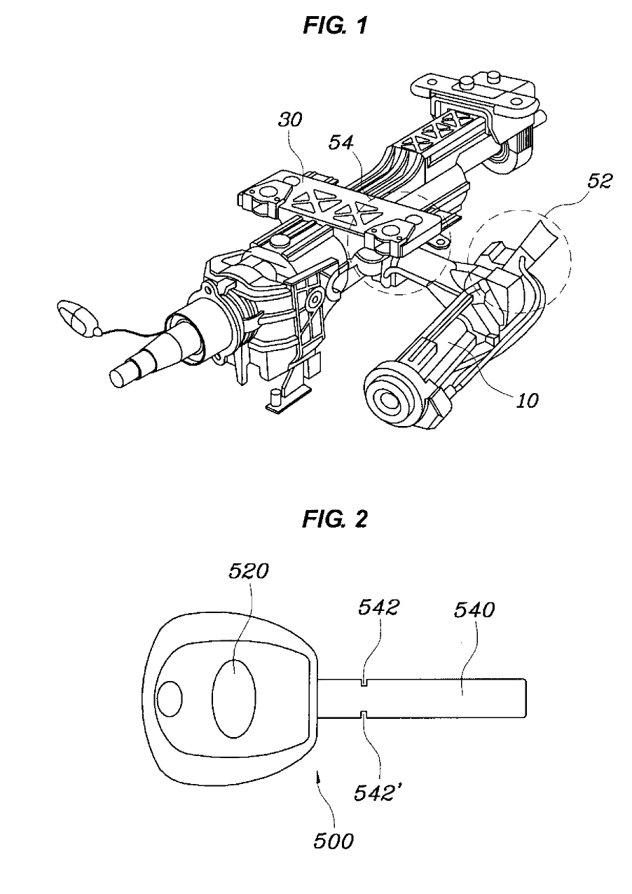

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Various embodiments of a key locking device for immobilizer systems according to present invention will be described below. These exemplary embodiments are characterized in that an immobilizer key having a notch is used and when the key is rotated, a stopper is locked to the notch so that the key is prevented from being released.

First, a key locking device for immobilizer systems according to some embodiments of the present invention will be described with reference to FIGS. 2 through 5.

The key locking device of the present invention prevents a vehicle key from being released after the key is inserted and rotated in an immobilizer system, which identifies a key by checking an identification code of the key with preset information.

The key locking device includes a rotor casing 100, a rotor 300, a disk 700 and a key 500.

The rotor casing 100 has a cylindrical inner space therein.

A retraction recess 110 is formed in an upper portion of the inner surface of the rotor casing 100. The rotor 300 is provided in the inner space of the rotor casing 100 so as to be rotatable therein.

A first key hole 310 is formed in the front end of the rotor 300, and a slot 330 is formed in the rotor 300 at a position adjacent to the retraction recess 110 of the rotor casing 100. The disk 700 is installed in the rotor and is elastically biased upwards.

A second key hole 720, into which the key 500 is inserted, is formed in the disk 700. A locking protrusion 740 is provided on the upper end of the disk 700.

The locking protrusion 720 can extend into the retraction recess 110 of the rotor casing 100 through the slot 330 of the rotor 300. The key 500 is inserted into the rotor 300 through the first key hole 310 and through the second key hole 720. A locking notch 542 is formed in the key 500.

Thus, when the key 500 is inserted into the rotor 300, the key 500 passes through the second key hole 720 of the disk 700 and moves the disk 700 downwards through a guide groove 350 such that the locking protrusion 740 of the disk 700 is released from the retraction recess 110, thus allowing the key 500 to be rotated along with the disk 700 and the rotor 300.

In addition, when the key 500 is in a rotated state, the disk 700 is inserted into the locking notch 542 of the key 500 so that the key 500 is prevented from being released from the rotor 300 as explained hereinafter.

FIG. 2 is a front view showing the key 500. The key 500, in various embodiments of the present invention, is provided with a handle part 520, which has an immobilizer code therein. The locking notch 542 is formed in an insert key portion 540 of the key 500. Preferably, the locking notch 542 comprises two locking notches 542 and 542′, which are formed at symmetric positions in respective opposite edges of the insert key portion 540 such that the key 500 is a symmetrical shape based on the longitudinal axis thereof Furthermore, the insert key portion 540 may have a straight bar shape.

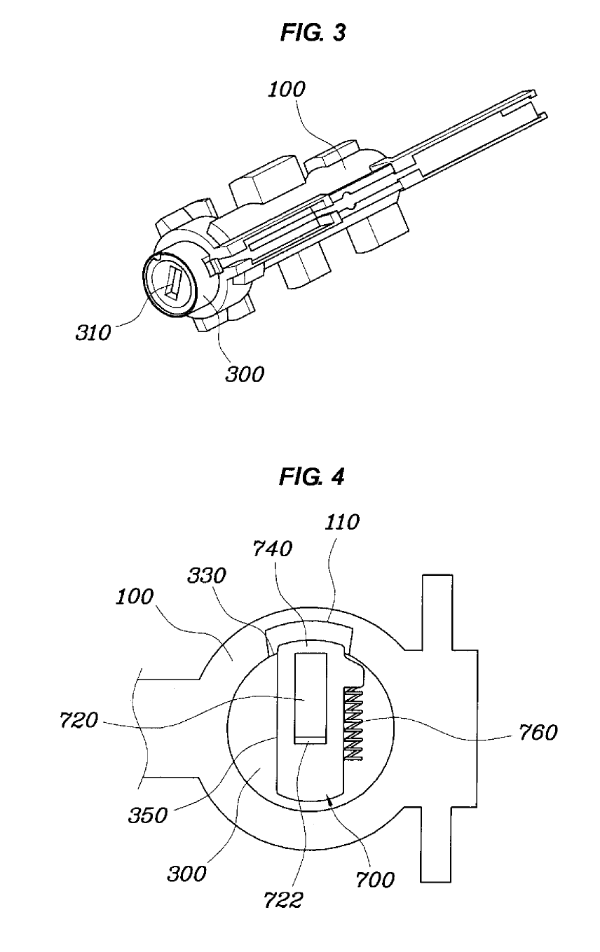

FIG. 3 shows the rotor casing 100 provided with the rotor 300. The rotor casing 100 has a cylindrical inner space therein. The rotor 300 is rotatably installed in the cylindrical inner space of the rotor casing 100. The first key hole 310, into which the key 500 is inserted, is formed in the front end of the rotor 300.

FIG. 4 is a sectional view of the key locking device according to various embodiments of the present invention, showing the installation of the disk 700. The retraction recess 110 is formed in the upper portion of the inner surface of the rotor casing 100. The disk 700 is installed in the rotor 300.

The disk 700 is movable upwards or downwards along the slot 330 of the rotor 300 along the guide groove 350.

A spring 760 is coupled at a first end thereof to a portion of the disk 700. The spring 760 is fastened at a second end thereof to the rotor 300 and biases the disk 700 in a radial direction of the rotor 300.

The locking protrusion 740, which is provided on the upper end of the disk 700, is removably inserted into the retraction recess 110 through the slot 330 of the rotor 300. The second key hole 720 is formed through the disk 700, and the key 500 is inserted into the second key hole 720.

The operation of the key locking device will be described below.

The key 500 is inserted into the rotor 300 through the first key hole 310 and then is inserted into the disk 700 through the second key hole 720.

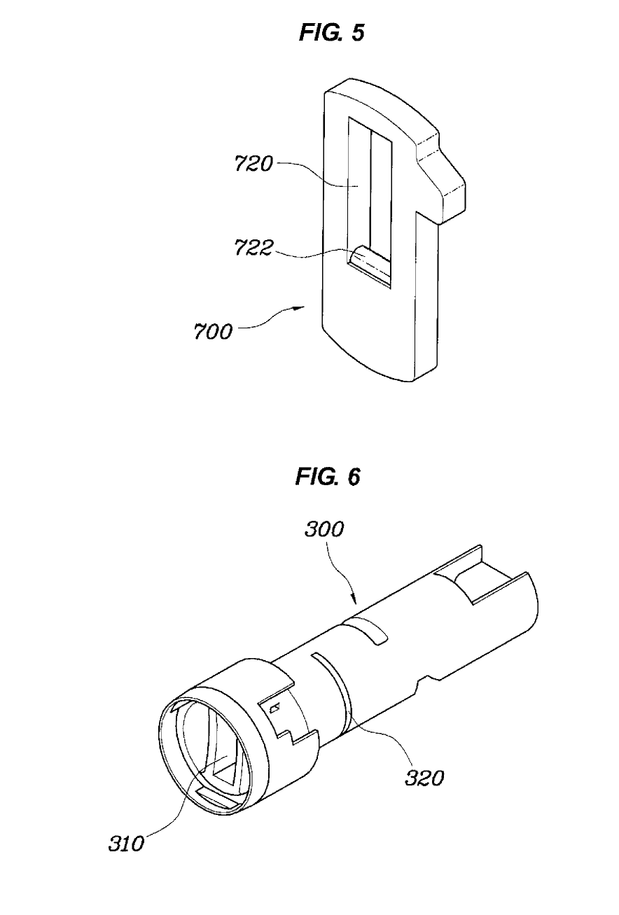

Here, the disk 700 has a contact protrusion 722, which is formed on the lower end of the second key hole 720, such that when the key 500 is inserted into the second key hole 720, the disk 700 is pushed downwards by the lower edge of the key 500 (refer to FIG. 5).

The contact protrusion 722 has inclined surfaces having a triangular shape.

Therefore, the disk 700, which is pushed by the key 500, overcomes the elastic force of the spring 760 and primarily moves downwards, that is, in the direction in which the locking protrusion 740 of the disk 700 is released from the retraction recess 110.

When the key 500 is completely inserted into the rotor 300, the contact protrusion 722 of the disk 700 is fitted into the lower locking notch 542′ of the key 500. From this state, when the key 500 is rotated, the locking protrusion 740 of the disk 700 is released from the retraction recess 110 by the rotating force of the key 500 and slides on the inner surface of the rotor casing 100, thus secondarily moving the disk 700 downwards.

The upper end of the disk 700 which is above the second key hole 720 is fitted into the upper locking notch 542 of the key 500 by the secondary downward movement of the disk 700. The key 500 is rotated along with the disk 700 and the rotor 300 in the rotor casing 100. At this time, the upper end of the disk 700 is in a state of having been inserted into the upper locking notch 542 of the key 500.

Therefore, even if the key 500 is pulled outwards while it is rotated, the disk 700 cannot be moved upwards by the inner surface of the rotor casing 100 and the key 500 is restricted by the disk 700, the upper end of which is inserted into the locking notch 542. Hence, the key 500 can be prevented from being undesirably released.

In contrast, when the key 500 is in reverse direction rotated to its initial position, the disk 700 is moved upwards by the spring 760 so that the upper end of the disk 700 is released from the upper locking notch 542 of the key 500 and the contact protrusion 722 of the disk 700 is inserted into the lower locking notch 542′.

In this state, when the key 500 is pulled outwards, the contact protrusion 722 of the disk 700 is released from the lower locking notch 542′ of the key 500, and the key 500 is released outwards from the key locking device. After the key 500 is released, the disk 700 is moved upwards to its original position.

Hereinafter, a key locking device for immobilizer systems according to other embodiments of the present invention will be described with reference to FIGS. 6 through 8. FIG. 6 is a perspective view of a rotor 300.

The rotor 300 is rotatably installed in an inner space of a rotor casing 100. A first key hole 310 is formed in the front end of the rotor 300. A flange insert slot 320 is formed at a predetermined position through the sidewall of the rotor 300. A flange 120 of the rotor casing 100 is slidably inserted into the flange insert slot 320.

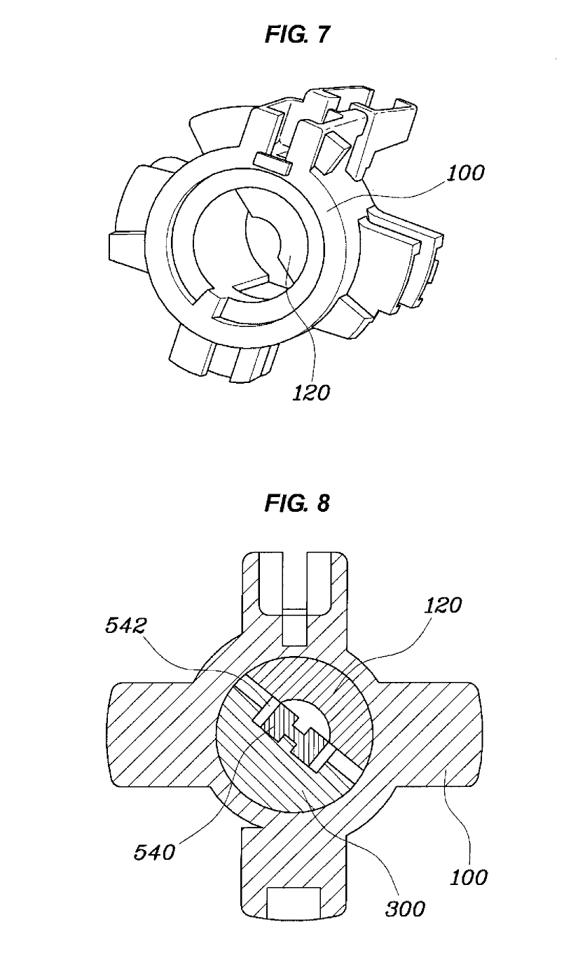

Referring to FIG. 7, the rotor casing 100 has the cylindrical inner space therein. The flange 120, which extends along a rotation trajectory of the key 500, is provided on the inner surface of the rotor casing 100.

Preferably, the flange 120 is provided in the rotor casing 100 such that when the key 500 is inserted into the rotor 300, the flange 120 is disposed on either of the left and right sides of the key 500.

The rotor 300 is rotatably installed in the rotor casing 100. Here, the flange 120 of the rotor casing 100 is inserted into the flange insert slot 320 of the rotor 300. The key 500 is inserted into the rotor 300 through the first key hole 310 and rotated along with the rotor 300.

A locking notch 542 is formed in the key 500 so that when the key 500 is rotated in the rotor casing 100, the flange 120 of the rotor casing 100 is inserted into and locked to the locking notch 542 of the key 500, thus preventing the key 500 from being released from the rotor casing 100.

FIG. 8 is a sectional view of the rotor casing 100, showing a section of the flange 120. The operation of various embodiments will be explained with reference to FIG. 8.

When the key 500 which is inserted into the rotor 300 is rotated in the rotor casing 100, the flange 120 of the rotor casing 100 is inserted into the locking notch 542 of the key 500. In this state in which the flange 120 is inserted into and locked to the locking notch 542, the key 500 is prevented from being released from the rotor 300. When the key is rotated to its initial position again, the flange 120 is released from the locking notch 542, thus enabling the key 500 to be released from the rotor 300.

As described above, a key locking device for immobilizer systems according to the present invention has a simple structure, thus reducing the production cost, and increasing the degree of freedom in the design. Furthermore, because the size of a key insert part is reduced, the danger of an injury to a user can be markedly reduced when a vehicle is involved in a collision.

For convenience in explanation and accurate definition in the appended claims, the terms “upper”, “lower”, “front”, “rear”, and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A key locking device for an immobilizer system which prevents a vehicle key from being released after the vehicle key is rotated from an initial position thereof, the immobilizer system identifying a user by checking an identification code of the vehicle key with stored information, the vehicle key locking device comprising:
a rotor casing having a cylindrical inner space therein, with a retraction recess formed in an inner surface of the rotor casing;
a rotor rotatably coupled to the rotor casing in the inner space thereof and having a first key hole formed in a front end of the rotor and a guide groove formed in the rotor at a position adjacent to the retraction recess of the rotor casing;
a disk slidably installed in the rotor through the guide groove, the disk being elastically biased outwards, with a second key hole formed in the disk so that the vehicle key passes through the second key hole, and a locking protrusion provided on an upper end of the disk, the locking protrusion selectively movable into the retraction recess of the rotor casing through the guide groove of the rotor according to rotation of the vehicle key; and
the vehicle key to be inserted into the rotor through the first key hole, with a locking notch formed in the vehicle key, so that when the vehicle key is inserted into the rotor, the vehicle key passes through the second key hole of the disk and moves the disk in a direction in which the locking protrusion of the disk is released from the retraction recess, and when the vehicle key is rotated along with the disk and the rotor from a position at which the vehicle key is inserted into the rotor, the disk is engaged with the locking notch of the vehicle key such that the vehicle key is prevented from being released from the rotor.

2. The key locking device as set forth in claim 1, wherein the disk is supported in the rotor by a spring so as to be movable along the guide groove formed in the rotor.

3. The key locking device as set forth in claim 1, wherein a contact protrusion is provided in a lower end of the second key hole so that when the vehicle key is inserted into the second key hole, the contact protrusion is pushed by a lower edge of the vehicle key and thus the disk is moved in the direction in which the locking protrusion of the disk is released from the retraction recess.

4. A key locking device for an immobilizer system which prevents a vehicle key from being released after the vehicle key is rotated from an initial position thereof, the immobilizer system identifying a user by checking an identification code of the vehicle key with stored information, the vehicle key locking device comprising:
a rotor casing having a cylindrical inner space therein, with a flange provided on an inner surface of the rotor casing, the flange extending a predetermined length along a rotation trajectory of the vehicle key;
a rotor rotatably coupled to the rotor casing in the inner space thereof, with a first key hole formed in a front end of the rotor, and a flange insert slot formed at a predetermined position in the rotor so that the flange of the rotor casing is slidably inserted into the flange insert slot; and
the vehicle key to be inserted into the rotor through the first key hole, with a locking notch formed in the vehicle key, so that when the vehicle key is rotated from a position at which the vehicle key is inserted into the rotor, the vehicle key rotates with the rotor and the flange of the rotor casing is inserted into and locked to the locking notch, thus preventing the vehicle key from being released from the rotor.

5. The key locking device as set forth in claim 4, wherein the flange is provided in the rotor casing such that when the vehicle key is inserted into the rotor, the flange is disposed on a side of the vehicle key.

6. A key locking device for an immobilizer system which prevents a vehicle key from being released after the vehicle key is rotated from an initial position thereof, the immobilizer system identifying a user by checking an identification code of the vehicle key with stored information, the vehicle key locking device comprising:
a rotor casing having an inner space therein;
a rotor rotatably coupled to the rotor casing in the inner space thereof and having a first key hole formed in a front end of the rotor;
a locking member selectively coupling the rotor, the rotor casing, and the vehicle key according to rotation of the vehicle key; and
the vehicle key to be inserted into the rotor through the first key hole and having a locking notch, so that when the vehicle key is inserted into the rotor through the first key hole and rotated along the rotor casing, the vehicle key activates the locking member to lock the vehicle key to the rotor through the locking notch of the vehicle key such that the vehicle key is prevented from being released from the rotor.

7. The key locking device as set forth in claim 6, wherein the rotor casing includes a retraction recess formed in an inner surface thereof, the rotor includes a guide groove formed in a co-axial direction with the retraction recess of the rotor casing, and the locking member includes a disk slidably installed in the guide groove of the rotor and elastically biased outwards, the disk having a second key hole so that when the vehicle key passes through the first and second key holes, the vehicle key moves the disk in a direction in which the disk is released from the retraction recess, and then when the vehicle key is rotated along with the disk, the disk is inserted into the locking notch of the vehicle key such that the vehicle key is prevented from being released from the rotor.

8. The key locking device as set forth in claim 7, wherein the locking notch of the vehicle key includes an upper locking notch and a lower locking notch, and when the vehicle key passes through the first and second key holes the disk is engaged with the lower locking notch of the vehicle key.

9. The key locking device as set forth in claim 8, wherein when the vehicle key is rotated along with the disk, the disk is released from the lower locking notch and inserted into the upper locking notch of the vehicle key such that the vehicle key is prevented from being released from the rotor.

10. The key locking device as set forth in claim 8, wherein the upper locking notch and the lower locking notch are disposed symmetrically with respect to a longitudinal axis of the vehicle key.

11. The key locking device as set forth in claim 7, wherein the disk is supported in the rotor by an elastic member so as to be movable along the guide groove formed in the rotor.

12. The key locking device as set forth in claim 11, wherein the elastic member is a spring.

13. The key locking device as set forth in claim 7, wherein a locking protrusion is provided on an upper end of the disk, the locking protrusion selectively moving into the retraction recess of the rotor casing by rotation of the vehicle key.

14. The key locking device as set forth in claim 7, wherein a contact protrusion is provided in a lower end of the second key hole so that when the vehicle key is inserted into the second key hole, the contact protrusion is pushed downwards by a lower edge of the vehicle key and the disk is thus moved in the direction in which the locking protrusion of the disk is released from the retraction recess.

15. The key locking device as set forth in claim 14, the contact protrusion is a triangular shape.

16. The key locking device as set forth in claim 6, wherein the rotor casing includes a flange integrally provided on an inner surface thereof, the flange extending in a predetermined length along a rotation trajectory of the vehicle key, and the rotor includes a flange insert slot along a rotation direction of the flange so that the flange of the rotor casing is inserted into the flange insert slot, and when the vehicle key is rotated from a position at which the vehicle key is inserted into the rotor, the vehicle key rotates with the rotor and the flange of the rotor casing is inserted into and locked to the locking notch, thus preventing the vehicle key from being released from the rotor.

17. The key locking device as set forth in claim 16, wherein the flange is provided in the rotor casing such that when the vehicle key is inserted into the rotor, the flange is disposed on one side of the vehicle key.

18. A passenger vehicle comprising the key locking device as set forth in claim 1.
